(19) United States
(12) Patent Application Publication
(10) Pub. No.: US 2004/0073422 A1
(43) Pub. Date: Apr. 15, 2004

(54) Apparatus and methods for surreptitiously recording and analyzing audio for later auditioning and application

(76) Inventors: Gregory A. Simpson, Vancouver (CA); Dan Timis, Mountain View, CA (US); Michael Ost, Sebastopol, CA (US); Christian Halaby, Atherton, CA (US)

Correspondence Address: Kenneth W. Float, The Law Offices of Kenneth W. Float, P.O. Box 80790, Rancho Santa Margarita, CA, 92688, US

(21) Appl. No.: 10/269,799

(22) Filed: Oct. 14, 2002

(51) Int. Cl. G10L 19/14

(52) U.S. Cl. 704/225

(57) ABSTRACT

Apparatus and corresponding methods, referred to as “stealth recording,” in which long audio segments are recorded into a buffer, then separated into individual phrases for auditioning and application. Stealth recording surreptitiously and continuously records audio processed thereby, then separates, catalogues, and time stamps the audio into phrases using, among other techniques, spectral analysis that compares the recorded audio to a sample of the ambient noise floor. This allows a user to instantly locate any phrase and audition or apply it within its proper context. This has numerous practical applications, ranging from musicians who wish to improvise then apply their most inspired phrases to a particular song, to students reviewing a lecture and replaying audio phrases in context with the visual information present at the time of the audio recording.

### BACKGROUND

The present invention relates generally to audio recording, and more particularly, to apparatus and methods that surreptitiously record and analyze audio for later auditioning and application.

Many musicians, when aware that they are being recorded, suffer from “recording anxiety.” Their performances become more constrained, losing some of the emotion and spontaneity that is inherent in the best musical performances. Musicians frequently create their best performances while warming up, experimenting, or improvising. Some musicians attempt to solve the anxiety problem by simply recording everything they play, but this presents its own set of problems, namely, how to audition all the recorded audio and how to find those few inspired performances in a lengthy improvisation.

Thus, if one wishes to solve the problem of “recording anxiety” by recording every performance, it is desirable to have apparatus and methods that enable one to find, audition, and apply the good performances, while simultaneously deleting the unwanted ones.

It is therefore an objective of the present invention to provide for apparatus and methods for surreptitiously recording and analyzing audio.

### SUMMARY OF THE INVENTION

To meet the above and other objectives, the present invention provides for apparatus and methods that separate long audio recordings into individual phrases, which can be individually auditioned, retained, applied, or discarded later. The present invention is of benefit to a wide range of audio recording applications including musical recordings, audio-for-film, conferencing products, court recording equipment, and classroom recording aids.

More particularly, the present invention provides for apparatus and a method, referred to as “stealth recording” that implements the following processes.

(a) The present invention quickly and effortlessly establishes a maximum signal level, which it uses to insure an optimal signal-to-noise ratio.

(b) The present invention establishes and “fingerprints” an ambient noise floor, which is used as an aid in separating the audio into phrases (as described in step d).

(c) The present invention surreptitiously records audio signals present at its input into a temporary buffer, whose contents are continuously analyzed (as discussed in step d) until the buffer is either saved or deleted. If the buffer fills without the performer taking action, the oldest buffered recordings will be replaced with newer ones.

(d) Audio is separated into individual phrases by comparing the spectral content of the recorded audio against the spectral fingerprint of the ambient noise floor. Whenever the spectral signal level rises above the ambient noise floor for a user-specified length of time, a new phrase is created and time stamped.

(e) A user interface indicates each new phrase in a manner most appropriate for the product. For example, each time a new phrase is detected, a hardware device might light an additional button in a row of buttons that correspond to phrases.

In the previous product user interface example, any phrase would be auditioned by merely pushing its corresponding button. The phrase, having been time stamped, would play “in synchronization” with any other recording happening at the same time (as in the case of a multi-track recording). Good phrases may be committed to the project at the push of a button. Bad phrases may be deleted just as easily. Entire record buffers may be deleted in a single action.

The present apparatus and methods, while they are specifically designed to benefit musicians as discussed herein, has many applications in various audio recording environments. Filmmakers, videographers and news reports, for example, could search audio phrases to rapidly locate important visual selections, which are synchronized to the time-coded audio. Secretaries taking notes in a classroom, meeting room, or courtroom could instantly locate random sections of a meeting for review or clarification.

### BRIEF DESCRIPTION OF THE DRAWINGS

The various features and advantages of the present invention may be more readily understood with reference to the following detailed description taken in conjunction with the accompanying drawings, wherein like reference numerals designate like structural elements, and in which:

FIG. 1 illustrates exemplary apparatus and “stealth recording” methods in accordance with the principles of the present invention; and

FIGS. 2 and 3 are simplified flow charts illustrating how recording levels are automatically optimized in the apparatus and “stealth recording” methods illustrated in FIG. 1.

### DETAILED DESCRIPTION

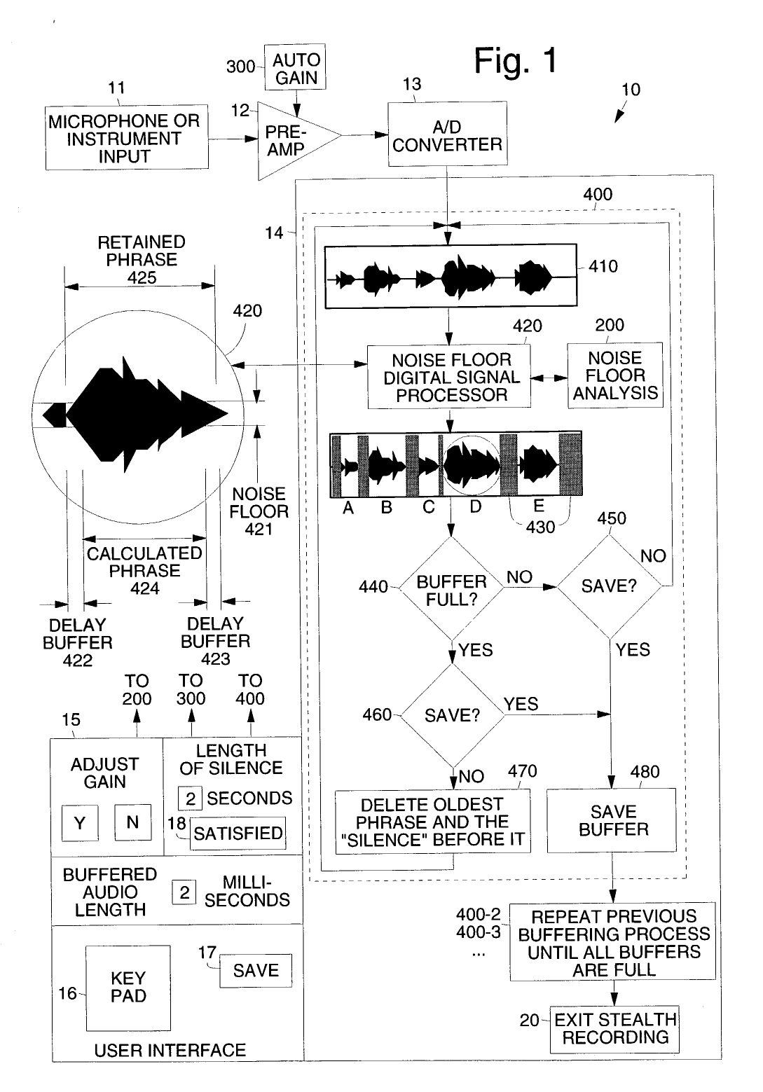

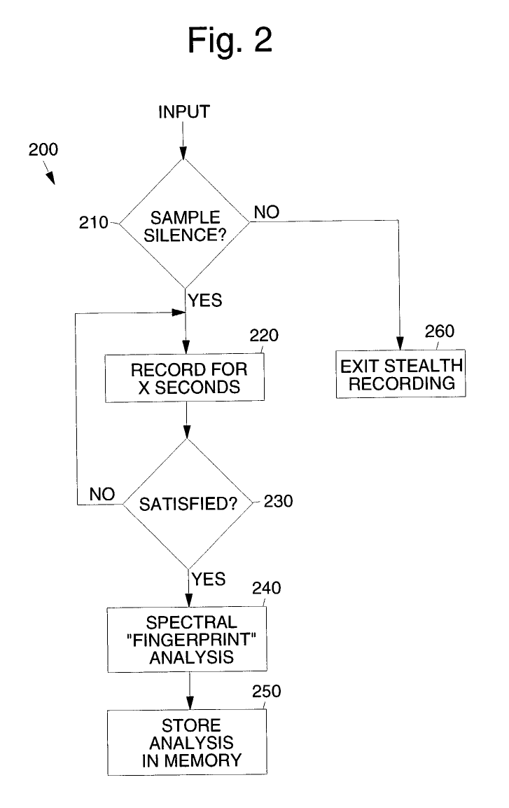

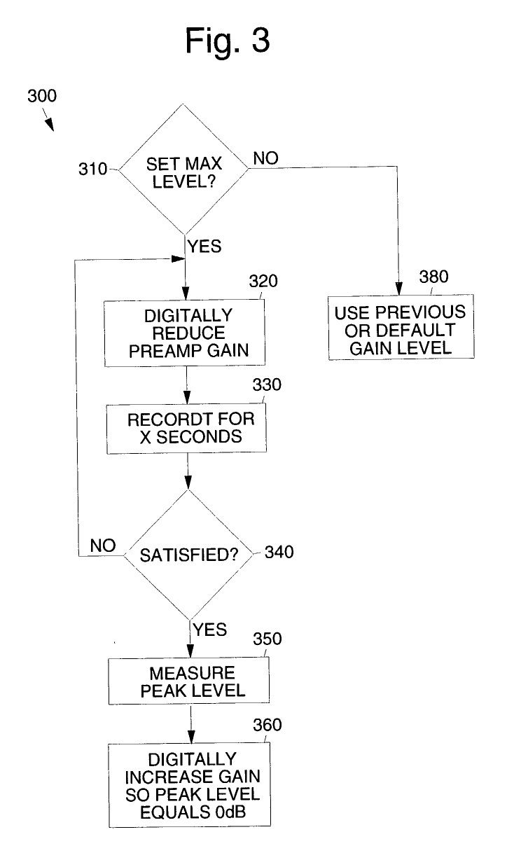

Referring to the drawing figures, exemplary apparatus 10 (FIG. 1) and “stealth recording” methods 100 (FIG. 3) in accordance with the principles of the present invention are shown. FIGS. 2 and 3 are simplified flow charts illustrating how recording levels are automatically optimized in the apparatus 10 and stealth recording methods 100. FIG. 2 shows a flow chart for a noise floor analysis sub-process 200, and an automatic gain sub-process 300 used in the stealth recording apparatus 10 and methods 100.

The exemplary stealth recording apparatus 10 comprises a microphone or instrument input 11 for receiving audio input signals from an instrument or microphone, which is coupled to an input of a preamplifier 12. An automatic gain sub-process 300 generates a gain control signal that controls the gain of the preamplifier 12. An output of the preamplifier 12 is coupled to an analog-to-digital (AID) converter 13. An output of the analog-to-digital converter 13 is coupled to a recording device 14, comprising a collection of buffering processes 400, 400-2, etc., using digital signals processing techniques 420, to separate and buffer the recordings A, B, C, D, etc., that implements the stealth recording method 100. A user interface 15 allows a user to operate the apparatus 10.

Audio recorders are used in many disciplines and, consequently, come in many forms. Presented below is a detailed description of each step in an exemplary stealth recording method 100 that is implemented in the apparatus 10, using a single “real world” example of how that step might be implemented in an actual musical recording product (the apparatus 10), although other product categories are supported by the present stealth recording apparatus 10 and methods 100.

The stealth recording method 100 first automatically establishes a proper gain setting in the automatic gain sub-process 300 for an optimum signal-to-noise ratio of the audio output signals input at the microphone or instrument input 11. The automatic gain sub-process 300 is illustrated in FIG. 3. The automatic gain sub-process 300 comprises the following steps.

A user is prompted by way of the user interface 15 whether to automatically adjust the input gain 310 (i.e., to set an optimized gain level 300 of the preamplifier 12). If the user does not agree (by selecting a No button (N) on the user interface 15, for example), a previously-used or default gain level 380 is used. If the user agrees (by selecting a Yes button (Y) on the user interface 15, for example) to automatically adjust the input gain 310, the input gain of the preamplifier 12 is digitally reduced 320 to a lower amplification level (−40 dB, for example). At this point, the apparatus 10 samples 330 the microphone or instrument input 11 for a predetermined amount of time (“X” seconds) and the user inputs the loudest sound that is likely to be made into the microphone or instrument input 11. For instance, a vocalist shouts into the microphone, or a musician plays a loud chord or note.

If the user is not satisfied 340 (No) with the maximum volume sample, the gain of the preamplifier 12 is again digitally reduced 320 to a lower amplification level. Once the user is satisfied 340 (Yes) with the maximum volume sample, the maximum peak level is measured 350 and the gain of the preamplifier 12 is automatically adjusted upward 360 such that the measured level is equal to 0 dB. The automatic gain setting sub-process 300 insures that recordings always have the best possible signal-to-noise ratio, freeing the performer from “riding” signal levels during a recording session.

The stealth recording method 100 then performs a noise floor analysis 200 using a noise floor digital signal processor 420. Details of this process are illustrated in FIG. 2. The noise floor analysis 200 first requests 210 a user-definable length of silence, typically 2-3 seconds. This length of time is input at the user interface 15 such as by using a keypad 16, for example. If the ambient noise floor is not continuous (city sounds or television audio in background, for example), a longer sample can be requested by inputting a new value using the keypad 16. During this time period, the user refrains from singing, speaking, or playing. The noise floor digital signal processor 420 in the recording device 14 records 220 the ambient noise in the room, including any wind noise, hum, electrical noise, fans or other ambient sounds that might be present.

The ambient noise is sampled and recorded by the noise floor digital signal processor 420 until the user is satisfied 230 with the ambient sample (that is, no extraneous or spurious noise was recorded during the sampling). The user depresses a “Satisfied” button 18 on the keypad 16 to indicate acceptance of the ambient sample. Then, a spectral analysis of this ambient noise sample is performed 240 and stored 250 in a memory (or buffer) in the noise floor digital signal processor 420. There are many types of available spectral analysis techniques, but typically, a series of windowed fast Fourier transforms (FFTs) are computed using an overlap-add technique. For example, a 1024-point FFT may be used with a Hanning window and half window overlap. An average of all the windows is computed and stored, although in general, only the power spectrum needs to be retained.

At this point, the recording device 14 begins to record automatically. All audio signals present at the input 11 are routed through the preamplifier 12, whose gain was set automatically by the automatic gain process 300. The signal is digitized by the A/D converter 13 and is temporarily written to a record buffer 410.

The noise floor digital signal processor 420 constantly compares the audio in the record buffer 410 with the ambient noise determined by the noise floor analysis 200, illustrated at the middle-left portion of FIG. 1. Whenever the audio signal level rises above a noise threshold 421 for a user-specified time, the stealth recording method 100 defines this as the beginning of an audio phrase. When the signal level drops below the noise threshold 421 for a user-specified time, the stealth recording method 100 defines this as the end of the audio phrase. The region between the beginning and end of the audio phrase is a calculated phrase 424. To assure smooth fade-ins and fade-outs, a user-specified length of buffered audio is added to the beginning 422 and end 423 of the phrase. A preferred embodiment of the invention may have a transition time on the order of from 1 to 100 milliseconds, for example. However, it is to be understood that other transition times may be employed at the discretion of the designer or user, and that the present invention is not limited to the above-cited range of transition times. This entire extended phrase 425 is retained and time-stamped. Buffered audio that is not associated with a phrase is discarded 430 and its space is made re-available newly recorded audio.

In this manner, audio is constantly being recorded into the record buffer 410 and the stealth recording method 100 is continuously analyzing the audio within the record buffer 410, to identify phrases, time stamp them, and flush the record buffer 410 of “silent” audio, which it reapplies to recording more phrases. The size of each the record buffer 410 is determined by specifying either a maximum number of phrases or a maximum length of “silent” audio.

In the case where a maximum number of phrases is specified, because the length of each phrase cannot be known in advance, the actual size of the buffer 410 (in megabytes) expands or contracts depending on the length of the phrases it contains. If the buffer 410 fills 440 without the user taking action 460, the oldest buffered phrase (and any silence that exists before it) is deleted 470 and replaced with the newest buffered phrase, and so on.

The result of this buffering is that a performer can play for as long as is desired without performance stress or anxiety. The performer is free to experiment, improvise, or practice as long as is desired. The performer does not interact with the recording hardware until something is played that is liked, at which point the stealth recording method 100 is activated such as by using a “Save” button 17 on the user interface 15, for example, to save the contents of the record buffer 410. Compare this to “traditional” recording in which the performer operates the recording device to indicate that “I'm going to record now,” then is “forced” to play something good. No wonder so many musicians suffer from “recording anxiety”.

The present apparatus 10 and stealth recording method 100 uses multiple buffer processes 400, 400-2, 400-3, for example, so, if a performer chooses to save 480 the contents of one record buffer 400, the performer can continue to play and performances will begin to aggregate in a new buffer 400-2, for example.

Because the audio has been digitally recorded, any phrase (A, B, C, D, E, etc) can be accessed immediately. This enables the performer to quickly audition the contents of the saved record buffer 400, 400-2, 400-3, for that “perfect take”.

Thus, apparatus and methods for surreptitiously recording and analyzing audio has been disclosed. It is to be understood that the described embodiment is merely illustrative of some of the many specific embodiments which represent applications of the principles of the present invention. Clearly, numerous and other arrangements can be readily devised by those skilled in the art without departing from the scope of the invention.

What is claimed is:

1. Apparatus for recording audio comprising:
an input for receiving audio input signals;
a preamplifier coupled to the input for preamplifying the audio input signals;
automatic gain setting apparatus coupled to a gain control input of the preamplifier;
an analog-to-digital converter coupled to an output of the preamplifier;
a signal processor comprising a recording device coupled to an output of the analog-to-digital converter that implements an audio recording method comprising the following steps:
processing audio input signals using the automatic gain setting apparatus to automatically establish a maximum signal level and optimum signal-to-noise ratio for audio input signals to be processed;
performing a noise floor analysis of audio input signals to establish and fingerprint an ambient noise floor for use in separating audio input signals to be processed into phrases;
recording audio input signals in a temporary buffer;
processing the audio input signals recorded in the temporary buffer to separate the audio input signals into individual phrases by comparing the spectral content of the recorded audio input signals against the spectral fingerprint of the ambient noise floor, and whenever the spectral signal level of the recorded audio input signal rises above the ambient noise floor for a user-specified length of time, creating and time stamping a new phrase; and
saving or deleting the contents of the temporary buffer.

2. The apparatus recited in claim 1 wherein the automatic gain setting is determined by:
asking a user whether to automatically adjust the input gain or use a previous or default gain level;
if the user agrees to automatically adjust the input gain, digitally reducing the input gain of the preamplifier to a lower amplification level;
sampling the input for a predetermined amount of time while the user inputs the loudest sound that is likely to be made;
if the user is satisfied with the gain level, measuring the maximum peak level once the user is satisfied with the gain level;
automatically adjusting the gain of the preamplifier upward such that the measured level is equal to 0 dB.
if the user is not satisfied with the gain level, further digitally reducing the input gain of the preamplifier to a lower amplification level until the user is satisfied with the gain level;
measuring the maximum peak level once the user is satisfied with the gain level; and
automatically adjusting the gain of the preamplifier upward such that the measured level is equal to 0 dB.

3. The apparatus recited in claim 1 wherein the loudest sound that is likely to be made by a vocalist is input by shouting into a microphone.

4. The apparatus recited in claim 1 wherein the loudest sound that is likely to be made by a musician is input by playing a loud chord or note.

5. The apparatus recited in claim 1 wherein the noise floor analysis is determined by:
requesting a user-definable length of silence wherein the user refrains from singing, speaking, or playing;
sampling and recording the ambient noise until the user is satisfied with the ambient sample;
performing a spectral analysis of the ambient noise sample;
storing the spectral analysis in memory.

6. The apparatus recited in claim 5 wherein, if the ambient noise floor is not continuous, a longer sample time is requested.

7. The apparatus recited in claim 5 wherein the step of performing the spectral analysis comprises computing a series of windowed fast Fourier transforms using an overlap-add technique.

8. The apparatus recited in claim 7 wherein the step of performing the spectral analysis comprises computing 1024-point fast Fourier transforms with a Hanning window and half window overlap.

9. The apparatus recited in claim 7 wherein the size of each buffer is determined by specifying both a maximum number of phrases and a maximum length of silent audio.

10. The apparatus recited in claim 7 wherein the step of recording input signals comprises the steps of:
recording audio input signals by temporarily storing them in a record buffer;
comparing the audio signals in the record buffer with the ambient noise determined by the noise floor analysis;
determining a calculated phrase by defining a beginning of an audio phrase when the audio signal level rises above a noise threshold for a user-specified time, and defining an end of the audio phrase when the signal level drops below the noise threshold for a user-specified time;
adding a user-specified length of buffered audio to the beginning and end of the calculated phrase to create an extended phrase;
storing and time stamping the extended phrase;
discarding audio signals that are not associated with a phrase to make space available for newly recorded audio.

11. A method for recording audio comprising the steps of:
processing audio input signals using the automatic gain setting apparatus to automatically establish a maximum signal level and optimum signal-to-noise ratio for audio input signals to be processed;
performing a noise floor analysis of audio input signals to establish and fingerprint an ambient noise floor for use in separating audio input signals to be processed into phrases;
recording audio input signals in a temporary buffer; and
processing the audio input signals recorded in the temporary buffer to separate the audio input signals into individual phrases by comparing the spectral content of the recorded audio input signals against the spectral fingerprint of the ambient noise floor, and whenever the spectral signal level of the recorded audio input signal rises above the ambient noise floor for a user-specified length of time, creating and time stamping a new phrase; and
saving or deleting the contents of the temporary buffer.

12. The method recited in claim 11 wherein the automatic gain setting is determined by:
asking a user whether to automatically adjust the input gain or use a previous or default gain level;
if the user agrees to automatically adjust the input gain, digitally reducing the input gain of the preamplifier to a lower amplification level;
sampling the input for a predetermined amount of time while the user inputs the loudest sound that is likely to be made;
if the user is satisfied with the gain level, measuring the maximum peak level once the user is satisfied with the gain level;
automatically adjusting the gain of the preamplifier upward such that the measured level is equal to 0 dB.
if the user is not satisfied with the gain level, further digitally reducing the input gain of the preamplifier to a lower amplification level until the user is satisfied with the gain level;
measuring the maximum peak level once the user is satisfied with the gain level; and
automatically adjusting the gain of the preamplifier upward such that the measured level is equal to 0 dB.

13. The method recited in claim 11 wherein the loudest sound that is likely to be made by a vocalist is input by shouting into a microphone.

14. The method recited in claim 11 wherein the loudest sound that is likely to be made by a musician is input by playing a loud chord or note.

15. The method recited in claim 11 wherein the noise floor analysis is determined by:
requesting a user-definable length of silence wherein the user refrains from singing, speaking, or playing;
sampling and recording the ambient noise until the user is satisfied with the ambient sample;
performing a spectral analysis of the ambient noise sample;
storing the spectral analysis in memory.

16. The apparatus recited in claim 15 wherein, if the ambient noise floor is not continuous, a longer sample time is requested.

17. The apparatus recited in claim 15 wherein the step of performing the spectral analysis comprises computing a series of windowed fast Fourier transforms using an overlap-add technique.

18. The apparatus recited in claim 17 wherein the step of performing the spectral analysis comprises computing 1024-point fast Fourier transforms with a Hanning window and half window overlap.

19. The apparatus recited in claim 17 wherein the size of each buffer is determined by specifying both a maximum number of phrases and a maximum length of silent audio.
